(19) United States
(12) Patent Application Publication
(10) Pub. No.: US 2009/0106151 A1
(43) Pub. Date: Apr. 23, 2009

(54) Fraud prevention based on risk assessment rule

(76) Inventors: Mark Allen Nelsen, Oakland, CA (US); Nancy Therese Hilgers, Danville, CA (US); Karl Newland, Pacifica, CA (US); Frederick Liu, Oakland, CA (US); Roger Paul Morrison, Menlo Park, CA (US); Andrew Brendan Carpenter, Belmont, CA (US); Sivakumar Seshappan, Fremont, CA (US); Craig M. Kato, Foster City, CA (US); Alan Scott, San Mateo, CA (US)

Correspondence Address: Visa USA c/o Duane Morris LLP;Attn: James Sze, Esq., 101 West Broadway, Suite 900, San Diego, CA, 92101, US

(21) Appl. No.: 11/974,987

(22) Filed: Oct. 17, 2007

(51) Int. Cl. G06Q 40/00

(52) U.S. Cl. 705/44

(57) ABSTRACT

A system, method, and computer-readable storage medium configured to import fraud prevention rules from an issuer and implement them in real-time at a payment processor. Usually, a card issuing bank either approves or declines financial transaction; however, in embodiments of the present invention, the issuing bank creates fraud prevention rules, and the payment processor implements the created rules. A payment processor apparatus comprises a network interface, and a verification engine. The verification engine includes a transaction driver, and a real time decisioning processor. The network interface is configured to receive a fraud prevention rule from a payment card issuing bank, and to receive a proposed financial transaction from an acquiring bank. The transaction driver receives the fraud prevention rule. The real time decisioning processor compares the proposed financial transaction from the acquirer and the fraud prevention rule to determine whether the proposed financial transaction should be declined.

### BACKGROUND

1. Field of the Invention

Aspects of the present invention relate in general to financial services. Aspects include a financial fraud prevention apparatus, system, method and computer-readable storage medium configured to import fraud prevention rules from an issuer and implement them in real-time at a payment processor.

2. Description of the Related Art

When a consumer cardholder makes a purchase from a merchant, a payment card can be used to pay for the transaction. The merchant forwards the financial transaction information to an acquiring bank (herein referred to as the “acquirer”). A payment processor (such as Visa™, MasterCard™, or American Express™) receives the transaction information and then forwards it to the payment card issuing bank (the “issuer”) for approval.

The issuer decides on whether or not to approve the cardholder's purchase.

The existing model requires issuers have a great deal of technical infrastructure in order to support payment cards. Additionally, maintaining the technical infrastructure is both expensive and difficult, as issuers must monitor and react to various types of payment card fraud. Issuers suffer a great deal of losses due to various fraud schemes.

### SUMMARY

Embodiments of the invention include a system and method configured to import fraud prevention rules from an issuer and implement them in real-time at a payment processor. Usually, a card issuing bank either approves or declines financial transaction; however, in embodiments of the present invention, the issuing bank creates fraud prevention rules, and the payment processor implements the created rules. A verification engine includes a transaction driver, and a real time decisioning processor. The network interface receives a fraud prevention rule from a payment card issuing bank, and a proposed financial transaction from an acquiring bank. The transaction driver receives the fraud prevention rule. The real time decisioning processor compares the proposed financial transaction from the acquirer and the fraud prevention rule to determine whether the proposed financial transaction should be declined.

### BRIEF DESCRIPTION OF THE DRAWINGS

FIG. 1a illustrates an embodiment of a system configured to import fraud prevention rules from an issuer and implement them in real-time at a payment processor.

FIG. 1b depicts an embodiment of a payment processor configured to import fraud prevention rules from an issuer and implement them in real-time.

FIG. 1c shows an embodiment of an issuer configured to upload fraud prevention rules to a payment processor that implements the rules in real-time.

FIG. 2 flowcharts a method embodiment in which a payment processor is configured to import fraud prevention rules from an issuer and implement them in real-time.

FIG. 3 is a flowchart of a method embodiment in which a payment processor implements fraud prevention rules received from an issuer and implements the rules in real-time.

FIG. 4 is a flowchart of an alternate method embodiment in which a payment processor implements fraud prevention rules received from an issuer and implements the rules in real-time.

FIG. 5 depicts a method embodiment in which an issuer implements, simulates and works fraud prevention rules.

FIG. 6 illustrates a method embodiment in which an issuer tests and verifies new fraud prevention rules.

FIG. 7 flowcharts a method embodiment in which an issuer works cases, determining whether there is fraud.

### DETAILED DESCRIPTION

One aspect of the present invention includes the realization that moving fraud detection and analysis from an issuer to a payment processor solves numerous problems. First, issuers will no longer need to maintain the technical infrastructure, and may outsource the work to the payment processor without ceding total control of their own proprietary fraud detection rules. More importantly, fraud detection rule implementation becomes centralized and easier to maintain. Fraud detection services may be sold by the payment processor to issuers. These and other benefits may be apparent in hindsight to one of ordinary skill in the art.

Embodiments of the present invention include a system, method, and computer-readable storage medium configured to import fraud prevention rules from an issuer and implement them in real-time at a payment processor. For the purposes of this application the terms “fraud prevention rule” and “real time decisioning rule” are synonymous, and may be used interchangeably. Other embodiments of the present invention may include remote terminals configured to create, test, and work fraud-prevention rules, so that the rules may be uploaded to the payment processor.

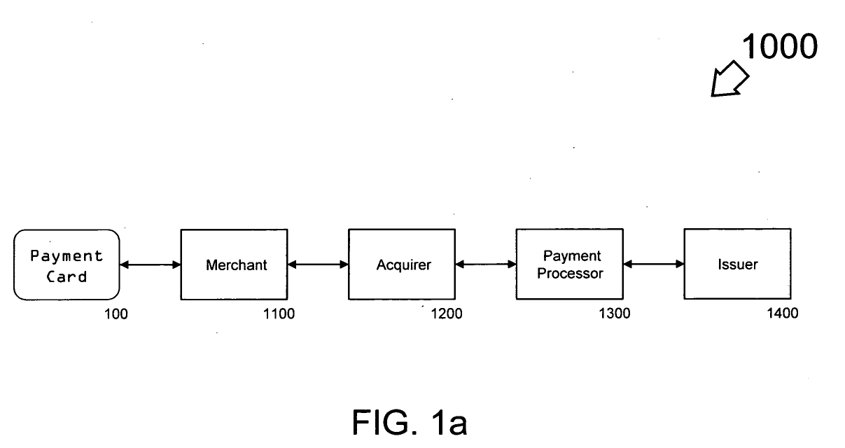

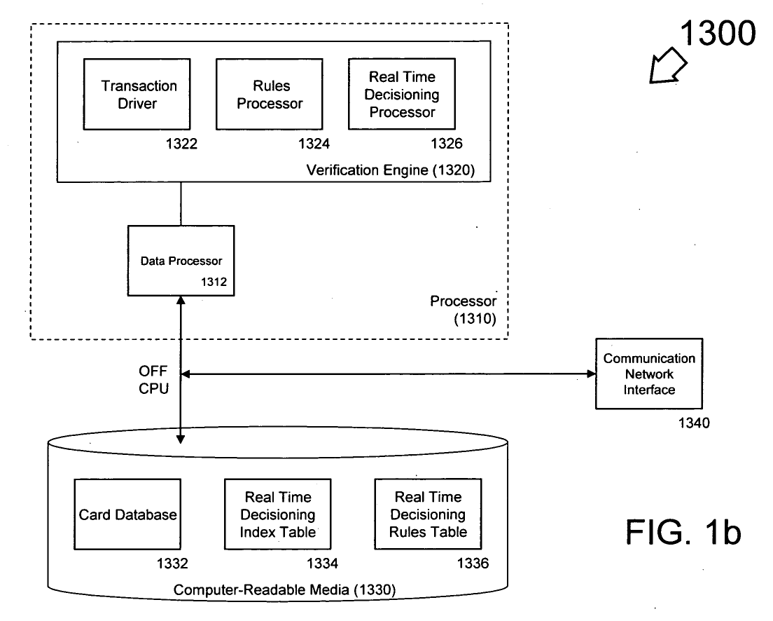

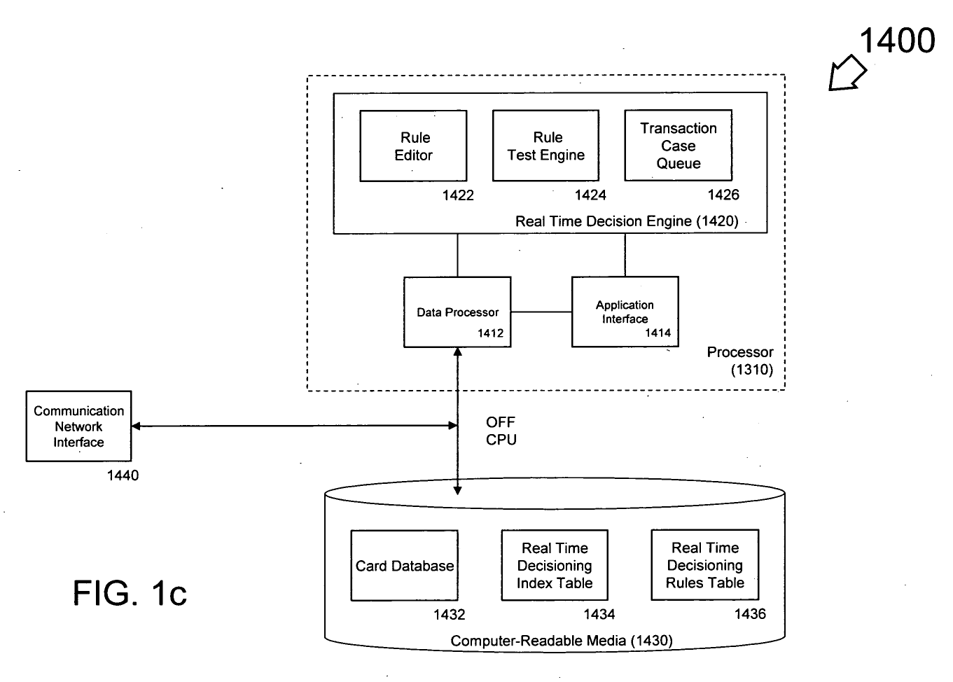

Turning to FIG. 1a-c, these figures depict system 1000, configured to import fraud prevention rules from an issuer and implement them in real-time at a payment processor, constructed and operative in accordance with an embodiment of the present invention. In this example, payment card 100 is assumed to be a credit card or debit card embodiment, but it is understood that other payment card equivalents may be substituted. These equivalents may include, but are not limited to: mobile phone, key tag, payment fob, or any other electronic payment device known in the art.

As shown in FIG. 1a, system 1000 supports importing fraud prevention rules from an issuer and implementing them in real-time at a payment processor, constructed and operative in accordance with an embodiment of the present invention. When the consumer uses the payment card 100 at a merchant 1100 to pay for a product or service, the merchant 1100 contacts an acquirer 1200 (for example, a commercial bank) to determine whether the consumer is credit worthy or the account has sufficient funds on the card to pay for the transaction. The acquirer 1200 forwards the details of the payment transaction to a payment processor 1300 for processing. It is understood that for backward compatibility payment card 100, merchant 1100, and acquirer 1200 may be any payment card, merchant and acquirer known in the art.

Payment processor 1300 may be any payment network configured to import fraud prevention rules from an issuer 1400, and implement the rules in real-time. Based on fraud prevention rules uploaded from issuer 1400, the payment processor 1300 determines whether the transaction should be allowed; in other instances, the payment processor 1300 queries the issuer 1400 to determine whether a debit payment card 100 has enough funds to allow the transaction. Internal details of payment processor 1300 are discussed below.

Issuer 1400 may be any payment card issuer configured to upload fraud prevention rules to a payment processor 1400 for implementation in real-time. In some instances, issuer 1400 may include a workstation capable of creating, testing, and uploading fraud prevention rules to payment processor 1300. Further details of issuer 1400 are also discussed below.

Embodiments will now be disclosed with reference to a block diagram of an exemplary payment processor 1300 of FIG. 1b, constructed and operative in accordance with an embodiment of the present invention. Payment processor 1300 may run a multi-tasking operating system (OS) and include at least one processor or central processing unit (CPU) 1310. Processor 1310 may be any central processing unit, microprocessor, micro-controller, computational device or circuit known in the art.

It is well understood by those in the art, that the functional elements of FIG. 1b may be implemented in hardware, firmware, or as software instructions and data encoded on a computer-readable storage medium 1330. As shown in FIG. 1b, processor 1310 is functionally comprised of a verification engine 1320 and data processor 1312. Verification engine 1320 may further comprise: transaction driver 1322, rules processor 1324, and real time decisioning processor 1326. These structures may be implemented as hardware, firmware, or software encoded on a computer readable medium, such as storage media 1330.

Data processor 1312 interfaces with storage medium 1330 and network interface 1340. The data processor 1312 enables processor 1310 to locate data on, read data from, and writes data to, these components.

Network interface 1340 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 1340 allows payment processor 1300 to communicate with issuer 1400, and may allow communication with acquirer 1200.

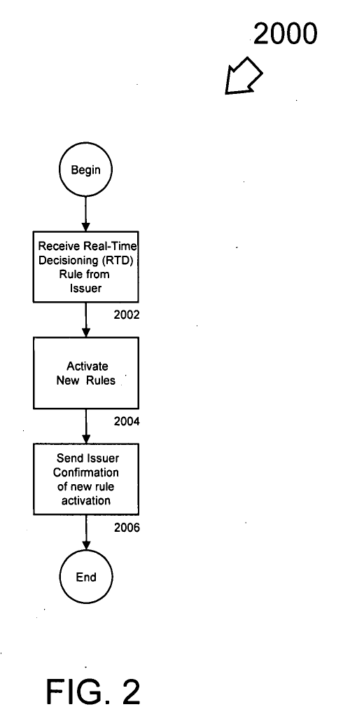

Computer-readable storage medium 1330 may be a conventional read/write memory such as a magnetic disk drive, floppy disk drive, compact-disk read-only-memory (CD-ROM) drive, digital versatile disk (DVD) drive, high definition digital versatile disk (HD-DVD) drive, magneto-optical drive, optical drive, flash memory, memory stick, transistor-based memory or other computer-readable memory device as is known in the art for storing and retrieving data. Significantly, computer-readable storage medium 1330 may be remotely located from processor 1310, and be connected to processor 1310 via a network such as a local area network (LAN), a wide area network (WAN), or the Internet. In addition, as shown in FIG. 1b, storage media 1330 may also contain a card database 1332, a real time decisioning index table 1334, and a master real time decisioning rules database 1336. The function of these structures may best be understood with respect to the flowcharts of FIGS. 2-7, as described below.

FIG. 1c shows an embodiment of an issuer 1400 configured to upload fraud prevention rules to a payment processor that implements the rules in real-time, constructed and operative in accordance with an embodiment of the present invention. It is understood by those known in the art that the issuer computing device 1400 may be configured on any computing device, such as a workstation, personal computer, mini-computer, mainframe, or other computing device known in the art. For illustrative purposes only, we will assume that the computing device located at the issuer 1400 is a computer workstation.

Issuer 1400 may run a multi-tasking operating system (OS) and include at least one processor or central processing unit 1410. Processor 1410 may be any central processing unit, microprocessor, micro-controller, computational device or circuit known in the art. It is further understood that processor 1410 does not have to be the same model or make as processor 1310.

Like the functional elements of FIG. 1b, it is well understood by those in the art, that the functional elements of FIG. 1c may be implemented in hardware, firmware, or as software instructions and data encoded on a computer-readable storage medium. As shown in FIG. 1c, processor 1410 is functionally comprised of a real time decisioning engine 1420, data processor 1412, and application interface 1414. Verification engine 1420 may further comprise: rule editor 1422, rule test engine 1424, and transaction case queue 1426. These structures may be implemented as hardware, firmware, or software encoded on a computer readable medium, such as storage media 1430.

Data processor 1412 interfaces with storage medium 1430 and network interface 1440. The data processor 1412 enables processor 1410 to locate data on, read data from, and writes data to, these components.

Network interface 1440 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 1440 allows issuer 1400 to communicate with payment processor 1300.

Application interface 1414 enables processor 1410 to take some action with respect to a separate software application or entity. For example, application interface 1414 may take the form of a graphical-user or windowing interface, as is commonly known in the art.

Computer-readable storage medium 1430 may be a conventional read/write memory such as a magnetic disk drive, floppy disk drive, compact-disk read-only-memory (CD-ROM) drive, digital versatile disk (DVD) drive, high definition digital versatile disk (HD-DVD) drive, magneto-optical drive, optical drive, flash memory, memory stick, transistor-based memory or other computer-readable memory device as is known in the art for storing and retrieving data. Significantly, computer-readable storage medium 1430 may be remotely located from processor 1410, and be connected to processor 1410 via a network such as a local area network (LAN), a wide area network (WAN), or the Internet. In addition, as shown in FIG. 1c, issuer storage media 1430 may contain structures analogous with that of payment processor storage media 1330. These structures include a card database 1432, a real time decisioning index table 1434, and a master real time decisioning rules database 1436. The function of these structures may best be understood with respect to the flowcharts of FIGS. 2-7, as described below.

We now turn our attention to method or process embodiments of the present invention, FIGS. 2-7. It is understood by those known in the art that instructions for such method embodiments may be stored on their respective computer-readable memory and executed by their respective processors.

FIG. 2 flowcharts a process 2000 in which a payment processor 1300 is configured to import fraud prevention rules from an issuer 1400 and implement the rules in real-time, constructed and operative in accordance with an embodiment of the present invention. At block 2002, payment processor network interface 1340 receives new rules from issuer 1400. The rules are indexed, stored and activated within real time decisioning index table 1334 and real time decisioning table 1336 by real time decisioning processor 1326, at block 2004. It is understood that in some embodiments, activation of rules may occur through a different sub-process. Additionally, it is understood that in yet other embodiments, real time decisioning index table 1334 and real time decisioning table 1336 may be one and the same. Once the rules are activated, verification engine 1320 sends issuer 1400 a notification confirming the new rule activation, block 2006.

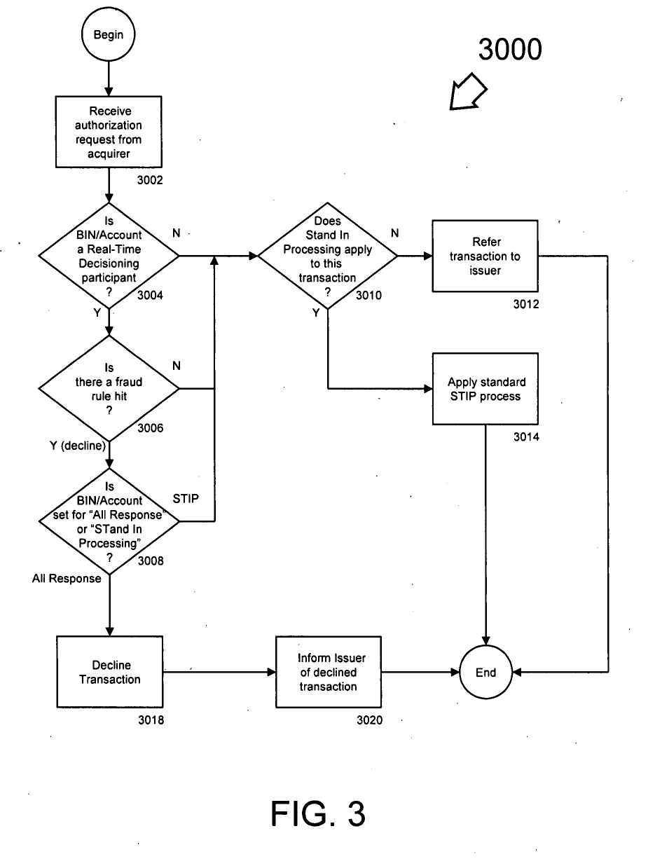

Moving to FIG. 3, process 3000 is method embodiment in which a payment processor 1300 implements fraud prevention rules received from issuer 1400 and implements the rules in real-time, constructed and operative in accordance with an embodiment of the present invention.

As discussed above, whenever a customer uses payment card 100 to pay for a financial transaction, the merchant 1100, and, in turn, acquirer 1200 seek authorization before performing the transaction. At block 3002, payment processor 1300 receives an authorization request from acquirer 1200. The authorization request contains a formatted data packet or packets containing information about the requested transaction, such as transaction amount, merchant name, and the customer's Primary Account Number (PAN). Usually, a customer's Primary Account Number is either a 15 or 16 digit number. The first six digits of a Visa™ or MasterCard™ Primary Account Number identifies the card issuer banking institution 1400 and is known as the “Bank Identification Number” or “BIN.” In debit transactions, the authorization request may also contain a user verification identifier, such as the customer's personal identification number (PIN) or biometric information.

At decision block 3004, the transaction driver 1322 determines whether the account referenced by Primary Account Number or the issuer 1400 represented by the Bank Identification Number participate in the real time decisioning process. If not, flow continues at block 3010. When the account's Primary Account Number or the Bank Identification Number participates in the real time decisioning process, flow continues at decision block 3006. In some instances, the transaction driver 1322 may make its determination through identifying Primary Account Numbers or Bank Identification Numbers listed in the card database 1332.

Whenever the fraud prevention rules identify a fraudulent transaction, it is referred to as a “fraud rule hit” and the real time decisioning processor 1326 declines the transaction at block 3006, and flow continues at block 3008. In applying the fraud detection rules, real time decisioning processor 1326 may apply fraud detection rules stored at the real time decisioning index table 1334 or real time decisioning rules table 1336. If no fraud is detected, flow continues at block 3010.

At block 3008, rules processor 1324 determines whether the Bank Identification Number or Account is set for all responses or whether Stand in Processing (“STIP”) should apply for this transaction. Stand in Processing is a backup system that provides authorization services on behalf of an issuer 1400 when the issuer 1400 or its authorizing processor is unavailable. If the BIN or account is marked for Stand in Processing, flow continues at block 3010. If the BIN or account is marked for all responses, flow continues at block 3018.

Returning to block 3010, if no Stand in Processing applies to the transaction, as determined by the transaction driver 1322, flow continues at block 3012, where the transaction driver 1322 allows the transaction, sends the transaction information to issuer 1400 via communication network interface 1340, and process 3000 ends. If no Stand in Processing applies to the transaction, the process flow continues at decision block 3014.

The standard Stand in Processing procedure applies, block 3014.

At block 3018, the transaction driver 1322 declines the transaction. When the transaction is declined, the acquirer 1200 is informed that that the transaction is not authorized. Furthermore, transaction driver 1322 informs the issuer of the declined transaction, block 3020. Process 3000 ends.

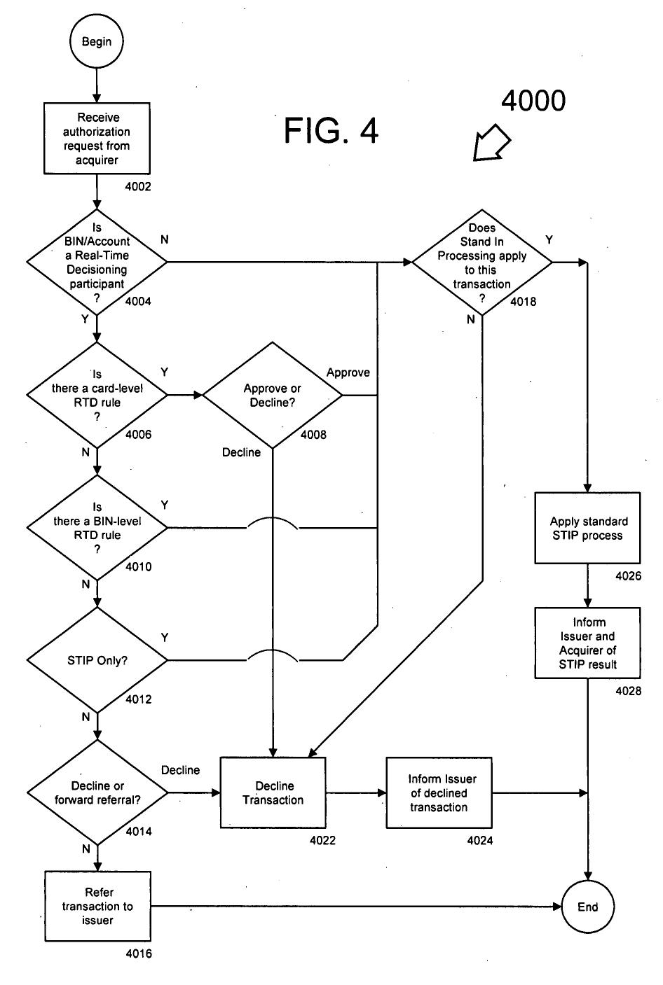

FIG. 4 is a flowchart of an alternate process 4000 in which a payment processor 1300 is implements fraud prevention rules received from an issuer 1400 and implements the rules in real-time, constructed and operative in accordance with an embodiment of the present invention.

At block 4002, payment processor 1300 receives an authorization request from acquirer 1200. The authorization request may be formatted as discussed above at FIG. 3.

At decision block 4004, the transaction driver 1322 determines whether the account referenced by Primary Account Number or the issuer 1400 represented by the Bank Identification Number participate in the real time decisioning process. If not, flow continues at block 4018. When the Primary Account Number or the Bank Identification Number participates in the real time decisioning process, flow continues at decision block 4006.

At decision block 4006, the real time decisioning processor 1326 decides whether there is a card-level real time decisioning rule that applies. Block 4006 may be accomplished when real time decisioning processor 1326 matches a card's primary account number against an entry in the card database 1332, real time decisioning index table 1334, or real time decisioning rules table 1336. A card-level real time decisioning rule is any rule that applies to a specific primary account number. For example, as a rule for extremely high value cardholders, their card may never be declined. For other customers, their card may be declined whenever their purchase amount exceeds a fixed sum, or whenever their total card balance exceeds a certain amount. If a card-level real time decisioning rule applies, flow continues at block 4008.

The real time decisioning processor 1326 applies the rule at decision block 4008, and either approves or declines the transaction. If the transaction is approved, process 4000 continues at block 4018. If the transaction is declined, flow continues at block 4022.

If no card-level rule applies, process 4000 determines whether there is a Bank Identification Numbers level rule, block 4010. If there is no BIN level rule, flow continues at block 4018; otherwise, flow continues at block 4012.

At decision block 4012, a check is made whether Stand in Processing is the only rule that should apply. If so, flow continues at block 4018. Otherwise, flow continues at block 4014.

At block 4014, verification engine 1320 determines whether the transaction should be forwarded to issuer 1400 for final determination block 4016, or declined at block 4022.

Returning to block 4018, if no Stand in Processing applies to the transaction, as determined by the transaction driver 1322, flow continues at block 4022.

If the standard Stand in Processing procedure applies, it is applied at block 4026. Both the issuer 1400 and acquirer 1200 are informed of the STIP result, and the process ends.

At block 4022, the transaction driver 1322 declines the transaction and the acquirer 1200 is informed that that the transaction is not authorized. Transaction driver 1322 informs the issuer 1400 of the declined transaction, block 4024. Process 4000 ends.

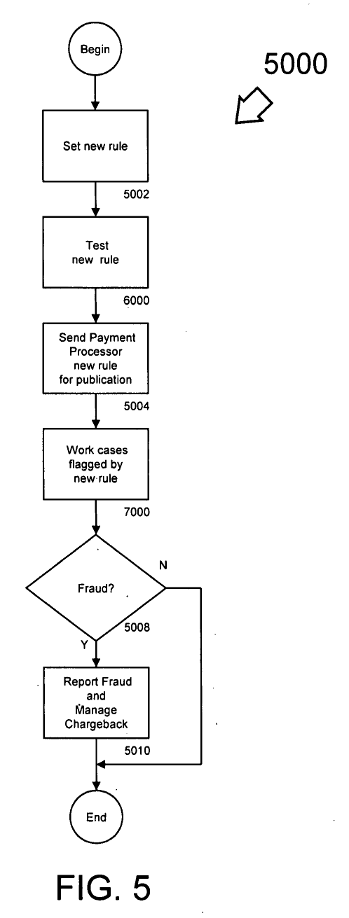

FIG. 5 depicts a method embodiment in which issuer 1400 implements, simulates and works fraud prevention rules, constructed and operative in accordance with an embodiment of the present invention. In one notable aspect of the present invention, an issuer 1400 may create (block 5002) and test (block 6000) their own issuer-specific rules on their own data. This data includes local card database 1432, local real time decisioning index table 1434, and local real time decisioning rules table 1436. The rules may be created and modified by a rule editor 1422. After the rules have been tested with a rule test engine 1424 at block 6000, they may be uploaded to payment processor 1300 for implementation, block 5004. When cases are flagged for inquiry by payment processor 1300 (such as at block 4016), cases are examined by issuer's employees (“worked”) at a transaction case queue 1426, block 7000, to determine whether the transaction should be declined, block 5008. If there transaction should be declined, the fraud is reported and a chargeback is managed, block 5010.

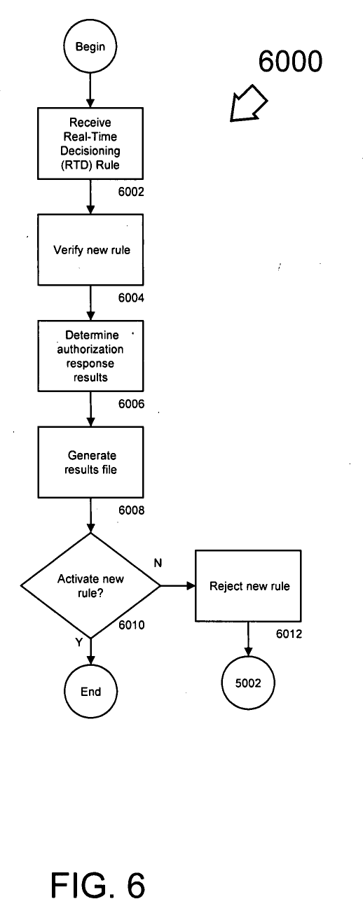

FIG. 6 illustrates a more detailed method embodiment 6000 in which issuer 1400 tests and verifies new fraud prevention rules, constructed and operative in accordance with an embodiment of the present invention. At block 6002, the rule test engine 1424 receives the real time decisioning rule. The real time decisioning rule may be received directly from rule editor 1422, real time decisioning rules table 1436. The rule is verified against sample fraudulent transaction data, block 6004, and the authorization responses are output, block 6006. In some embodiments the results are generated as a file, block 6008. Comparing the results against the known sample data, the issuer 1400 determines whether the rule is useful. If useful in detecting fraudulent transactions, the new rule is activated, block 6010. If the rule is not useful, it is rejected at block 6012, and the process flow returns to block 5002 of FIG. 5.

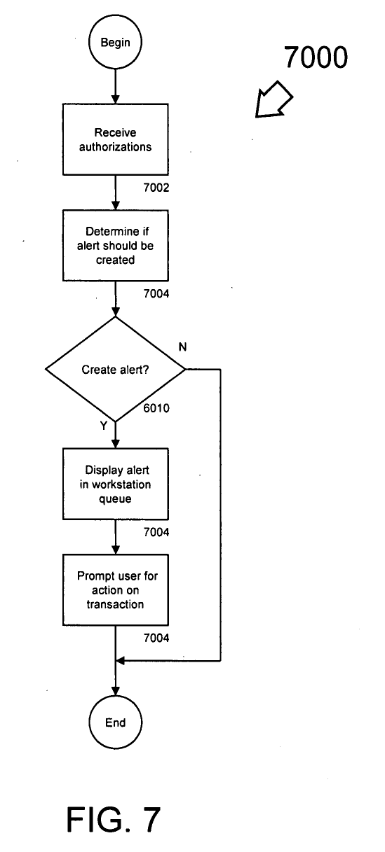

FIG. 7 flowcharts a method embodiment in which issuer 1400 works cases, determining whether there is fraud, constructed and operative in accordance with an embodiment of the present invention. At block 7002, the transaction case queue 1426 receives a list of authorized transactions. The issuer 1400 determines whether an alert should be created 7004. An alert may need to be created if the transaction case queue received a transaction that is suspicious, or needs human intervention. If no alert is needed, flow ends. If the an alert is needed, as determined by decision block 7004, an alert is displayed in the workstation transaction case queue 1426, block 7006, prompting a user for action on the transaction, block 7008.

The previous description of the embodiments is provided to enable any person skilled in the art to practice the invention. The various modifications to these embodiments will be readily apparent to those skilled in the art, and the generic principles defined herein may be applied to other embodiments without the use of inventive faculty. Thus, the present invention is not intended to be limited to the embodiments shown herein, but is to be accorded the widest scope consistent with the principles and novel features disclosed herein.

What is claimed is:

1. A payment processor apparatus comprising:
a network interface configured to receive a fraud prevention rule from an issuer, and to receive a proposed financial transaction from an acquirer;
a transaction driver configured to receive the fraud prevention rule;
a real time decisioning processor to compare the proposed financial transaction from the acquirer and the fraud prevention rule, the comparison determining whether the proposed financial transaction should be declined; and,
the network interface being further configured to transmit a decline message to the acquirer when the proposed financial transaction should be declined.

2. The payment processor apparatus of claim 1, further comprising:
wherein the proposed financial transaction contains a primary account number (PAN), the account number containing a Bank Identification Number (BIN).

3. The payment processor apparatus of claim 2, further comprising:
a card database configured to store an account record, the account record associated with an account number

4. The payment processor apparatus of claim 3, further comprising:
a rules database configured to store the fraud prevention rule.

5. The payment processor apparatus of claim 4, further comprising:
wherein the transaction driver is further configured to compare the primary account number with the account record to determine whether the proposed financial transaction should be compared with the fraud prevention rule.

6. The payment processor apparatus of claim 4, further comprising:
wherein the network interface is further configured to transmit an approval message to the acquirer and the issuer when the financial transaction is not fraudulent.

7. The payment processor apparatus of claim 6, further comprising:
wherein the network interface is further configured to transmit a transaction summary message to the issuer.

8. A payment processor method comprising:
receiving a fraud prevention rule from an issuer;
receiving a proposed financial transaction from an acquirer;
comparing the proposed financial transaction from the acquirer and the fraud prevention rule, to determine whether the proposed financial transaction should be declined; and,
transmitting a decline message to the acquirer when the proposed financial transaction should be declined.

9. The payment processor method of claim 8, wherein the proposed financial transaction contains a primary account number (PAN), the account number containing a Bank Identification Number (BIN).

10. The payment processor method of claim 9, further comprising:
storing an account record in a card database, the account record associated with an account number

11. The payment processor method of claim 10, further comprising:
storing the fraud prevention rule in a rules database.

12. The payment processor method of claim 11, further comprising:
comparing the primary account number with the account record to determine whether the proposed financial transaction should be compared with the fraud prevention rule.

13. The payment processor method of claim 11, further comprising:
transmitting an approval message to the acquirer and the issuer when the financial transaction is not fraudulent.

14. The payment processor method of claim 13, further comprising:
transmitting a transaction summary message to the issuer.

15. A computer-readable storage medium, encoded with data and instructions, such that when executed by a device, the instructions causes the device to:
receive a fraud prevention rule from an issuer;
receive a proposed financial transaction from an acquirer;
compare the proposed financial transaction from the acquirer and the fraud prevention rule, to determine whether the proposed financial transaction should be declined; and,
transmit a decline message to the acquirer when the proposed financial transaction should be declined.

16. The computer-readable storage medium of claim 15, wherein the proposed financial transaction contains a primary account number (PAN), the account number containing a Bank Identification Number (BIN).

17. The computer-readable storage medium of claim 16, further comprising instructions to:
store an account record in a card database, the account record associated with an account number

18. The computer-readable storage medium of claim 17, further comprising instructions to:
store the fraud prevention rule in a rules database.

19. The computer-readable storage medium of claim 18, further comprising instructions to:
compare the primary account number with the account record to determine whether the proposed financial transaction should be compared with the fraud prevention rule.

20. The payment processor method of claim 18, further comprising instructions to:
transmit an approval message to the acquirer and the issuer when the financial transaction is not fraudulent.
